(19) United States
(12) Patent Application Publication
(10) Pub. No.: US 2011/0296404 A1
(43) Pub. Date: Dec. 1, 2011

(54) SYSTEMS AND METHODS FOR HOST-LEVEL DISTRIBUTED SCHEDULING IN A DISTRIBUTED ENVIRONMENT

(75) Inventors: Weijia Zhang, Round Rock, TX (US); Mohammad Dhedhi, Round Rock, TX (US); Muninder Arram, Round Rock, TX (US)

(73) Assignee: DELL PRODUCTS L.P.

(21) Appl. No.: 12/791,584

(22) Filed: Jun. 1, 2010

(51) Int. Cl. G06F 9/445

(52) U.S. Cl. 717/178

(57) ABSTRACT

A system for host-level distributed scheduling of a software installation in a distributed computer environment is disclosed. An information handling system includes an out-of-band processor operable to communicatively connect to a second information handling system via a network. The information handling system is configured to: retrieve an identifier indicative of a software installation consequent to a software installation request being invoked; download a software installation package via the network, where the software installation package includes a payload; store the payload in an image repository; schedule the software installation to occur based, at least in part, on the identifier and a timing parameter; store software installation information in a nonvolatile memory medium; and perform the software installation according to the scheduling. The scheduling and the performing of the software installation is without dependency on communicative connection to the network.

### TECHNICAL FIELD

The present disclosure relates generally to information handling systems and, more particularly, to systems and methods for host-level distributed scheduling in a distributed environment.

### BACKGROUND

As the value and use of information continues to increase, individuals and businesses seek additional ways to process and store information. One option available to these users is an information handling system. An information handling system generally processes, compiles, stores, and/or communicates information or data for business, personal, or other purposes thereby allowing users to take advantage of the value of the information. Because technology and information handling needs and requirements vary between different users or applications, information handling systems may vary with respect to the type of information handled; the methods for handling the information; the methods for processing, storing or communicating the information; the amount of information processed, stored, or communicated; and the speed and efficiency with which the information is processed, stored, or communicated. The variations in information handling systems allow for information handling systems to be general or configured for a specific user or specific use such as financial transaction processing, airline reservations, enterprise data storage, or global communications. In addition, information handling systems may include or comprise a variety of hardware and software components that may be configured to process, store, and communicate information and may include one or more computer systems, data storage systems, and networking systems.

Managing a plurality of servers in a remote environment presents many hurdles. One major one is network bandwidth and reliability during systems management. For example, when an update or operating system (OS) deployment command is sent and all systems under management start applying the same payload at the same time, it generates significant network bandwidth issues. Another problem is that target systems under management might be running different OSs and in various states in which some of them might not be able to have an agent to receive the command at a particular moment when updates or deployments are expected. Accordingly, it is desirable to provide systems and methods that address the challenges of management in a distributed computing environment.

### SUMMARY

The present disclosure relates generally to information handling systems and, more particularly, to systems and methods for host-level distributed scheduling in a distributed environment.

In one aspect, a system for host-level distributed scheduling of a software installation in a distributed computer environment is disclosed. An information handling system includes an out-of-band processor operable to communicatively connect to a second information handling system via a network. The information handling system is configured to: retrieve an identifier indicative of a software installation consequent to a software installation request being invoked; download a software installation package via the network, where the software installation package inlcudes a payload; store the payload in an image repository; schedule the software installation to occur based, at least in part, on the identifier and a timing parameter; store software installation information in a nonvolatile memory medium; and perform the software installation according to the scheduling. The scheduling and the performing of the software installation is without dependency on communicative connection to the network. One or more of the retrieving, downloading, storing the payload, scheduling, and storing software installation information is performed, at least in part, with the out-of-band processor.

In another aspect, a method for host-level distributed scheduling of a software installation in a distributed computer environment is disclosed. An information handling system that is operable to communicatively connect to a second information handling system via a network is provided. The information handling system is configured to: retrieve an identifier indicative of a software installation consequent to a software installation request being invoked; download a software installation package via the network, wherein the software installation package includes a payload; locally store the payload in an image repository; schedule the software installation to occur based, at least in part, on the identifier and a timing parameter; store software installation information in a nonvolatile memory medium; and perform the software installation according to the scheduling, wherein the scheduling and the performing of the software installation is without dependency on the information handling system being communicatively connected to the network.

In yet another aspect, a computer-readable storage medium is disclosed. The computer-readable storage medium includes executable instructions that, when executed by a processor of an information handling system that is operable to communicatively connect to a second information handling system via a network, cause the processor to: retrieve an identifier indicative of a software installation consequent to a software installation request being invoked; download a software installation package via the network, where the software installation package includes a payload; locally store the payload in an image repository; schedule the software installation to occur based, at least in part, on the identifier and a timing parameter; store software installation information in a nonvolatile memory medium; and perform the software installation according to the scheduling, where the scheduling and the performing of the software installation is without dependency on the information handling system being communicatively connected to the network.

Thus, the present disclosure provides systems and methods for host-level distributed scheduling in a distributed environment.

Certain embodiments provide a technology for distributed remote scheduling with adjustable network dependency and no dependency on the state of the host system. Certain embodiments provide a key embedded systems management capability that allows systems administrators to use a simple standard interface to manage servers with remote rescheduling, update, and deployment capabilities. Certain embodiments provide a distributed scheduling infrastructure that allows payload and configurations to be pushed onto target systems prior to time of operation. Other technical advantages will be apparent to those of ordinary skill in the art in view of the specification, claims and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features.

FIG. 1 illustrates a block diagram of an example distributed computing environment in accordance with certain embodiments of the present disclosure.

FIG. 2 illustrates a job control framework in accordance with certain embodiments of the present disclosure.

FIG. 3 shows a control flow diagram in accordance with certain embodiments of the present disclosure.

FIG. 4 shows an architectural data flow diagram in accordance with certain embodiments of the present disclosure.

While embodiments of this disclosure have been depicted and described and are defined by reference to exemplary embodiments of the disclosure, such references do not imply a limitation on the disclosure, and no such limitation is to be inferred. The subject matter disclosed is capable of considerable modification, alteration, and equivalents in form and function, as will occur to those skilled in the pertinent art and having the benefit of this disclosure. The depicted and described embodiments of this disclosure are examples only, and not exhaustive of the scope of the disclosure.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, read-only memory (ROM), and/or other types of nonvolatile memory. Additional components of the information handling system may include one or more disk drives, one or more network ports for communication with external devices as well as various input and output (I/O) devices, such as a keyboard, a mouse, and a video display. The information handling system may also include one or more buses operable to transmit communications between the various hardware components.

Illustrative embodiments of the present invention are described in detail below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of the present disclosure.

For the purposes of this disclosure, computer-readable media may include any instrumentality or aggregation of instrumentalities that may retain data and/or instructions for a period of time. Computer-readable media may include, for example without limitation, storage media such as a direct access storage device (e.g., a hard disk drive or floppy disk), a sequential access storage device (e.g., a tape disk drive), compact disk, CD-ROM, DVD, RAM, ROM, electrically erasable programmable read-only memory (EEPROM), and/or flash memory; as well as communications media such wires, optical fibers, microwaves, radio waves, and other electromagnetic and/or optical carriers; and/or any combination of the foregoing.

Certain embodiments provide a technology for distributed remote scheduling with adjustable network dependency and no dependency on the state of the host system. A key embedded systems management capability may allow systems administrators to use a simple standard interface to manage servers with remote scheduling, rescheduling, update, and deployment capabilities. A distributed scheduling infrastructure may allow payload and configurations to be pushed onto target systems prior to time of operation. A target system may have its own scheduling demon and job store that takes over the scheduling function and hence does not have dependency on centralized server and network resources. As opposed to controlling scheduling on the console side, certain embodiments provide for distributed scheduling at the level of the target system. The target system would not require connectivity to the network resources when the scheduled work is being performed. As opposed to “centralized schedulers,” certain embodiments provide for distributed scheduling at the host level that allows staged updating with a downloading stage and a distributed scheduling stage, thereby eliminating network bandwidth congestion.

Certain embodiments may provide a system for host-level distributed scheduling of a software installation in a distributed computer environment by employing an out-of-band processor. For example, the out-of-band processor may, at least in part, establish remote enablement network connectivity. The out-of-band processor may receive remote commands, process commands, and stage payloads and operation sequences for an in-band processor if needed. The out-of-band processor may initiate an operation to allow the in-band processor to process the operation steps as staged by the out-of-band processor via a system service manager (SSM). Further, the embodiments disclosed herein may be implemented in a variety of configurations and certain configurations may include an out-of-band processor configured to perform, at least in part, one or more of the functions, steps, and/or features of the embodiments.

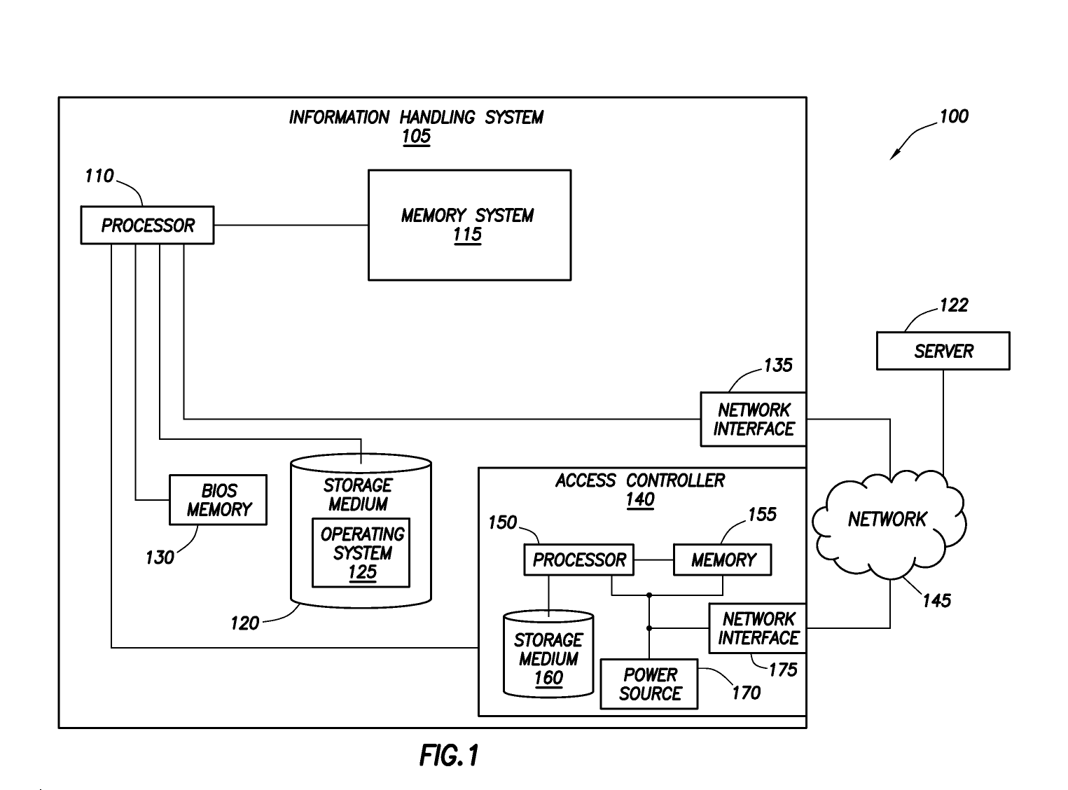

FIG. 1 illustrates a block diagram of an example distributed computing environment 100, in accordance with certain embodiments of the present disclosure. The distributed computing environment 100 may include one or more information handling systems 105. In certain embodiments, the information handling systems 105 may include a computer chassis or enclosure (e.g., a server chassis holding one or more server blades). In other embodiments, information handling system 105 may be a personal computer (e.g., a desktop computer or a portable computer). As depicted in FIG. 1, information handling system 105 may include a processor 110, a memory system 115 communicatively coupled to processor 110, and a storage medium 120 communicatively coupled to the processor 110.

The processor 110 may include any system, device, or apparatus configured to interpret and/or execute program instructions and/or process data, and may include, without limitation a microprocessor, microcontroller, digital signal processor (DSP), application specific integrated circuit (ASIC), or any other digital or analog circuitry configured to interpret and/or execute program instructions and/or process data. In some embodiments, the processor 110 may interpret and/or execute program instructions and/or process data stored and/or communicated by one or more of memory system 115, storage medium 120, and/or another component of information handling system 105. The processor 110 may be coupled to other components (not shown) with optional interfaces (I/Fs) via a PCIe (Peripheral Component Interconnect Express) interface, for example.

The memory system 115 may include any system, device, or apparatus operable to retain program instructions or data for a period of time (e.g., computer-readable media). For example without limitation, the memory system 115 may include RAM, EEPROM, a PCMCIA card (Personal Computer Memory Card International Association standard conformant expansion card), flash memory, magnetic storage, opto-magnetic storage, or any suitable selection and/or array of volatile or non-volatile memory that retains data after power to the information handling system 105 is turned off. In particular embodiments, the memory system 115 may comprise dynamic random access memory (DRAM).

Storage medium 120 may be communicatively coupled to processor 110. Storage medium 120 may include any system, device, or apparatus operable to store information processed by processor 110. Storage medium 120 may include, for example, network attached storage, one or more direct access storage devices (e.g., hard disk drives), and/or one or more sequential access storage devices (e.g., tape drives). As shown in FIG. 1, storage medium 120 may have stored thereon an operating system (OS) 125. OS 125 may be any program of executable instructions, or aggregation of programs of executable instructions, configured to manage and/or control the allocation and usage of hardware resources such as memory, CPU time, disk space, and input and output devices, and provide an interface between such hardware resources and application programs hosted by OS 125. Active portions of OS 125 may be transferred to memory 115 for execution by processor 110.

A basic input/output system (BIOS) memory 130 may be included in or be separate from the memory system 110. A flash memory or other nonvolatile memory may be used as the BIOS memory 130. A BIOS program (not expressly shown) may typically be stored in the BIOS memory 130. The BIOS program may include software that facilitates interaction with and between the information handling system 110 devices such as a keyboard (not expressly shown), a mouse (not expressly shown), and/or one or more I/O devices. The BIOS memory 130 may also store system code (note expressly shown) operable to control a plurality of basic information handling system 110 operations. Information handling system 105 may operate by executing BIOS for a system firmware in response to being powered up or reset. BIOS may identify and initialize components of system 100 and cause an operating system to be booted.

As depicted in FIG. 1, information handling system 105 may also include a network interface 135 communicatively coupled to processor 110, and an access controller 140 coupled to processor 110. Network interface 135 may include any suitable system, apparatus, or device operable to serve as an interface between information handling system 105 and network 145. Network interface 135 may enable information handling system 105 to communicate over network 145 using any suitable transmission protocol and/or standard, including without limitation all transmission protocols and/or standards enumerated below with respect to the discussion of network 145. In certain embodiments, network interface 135 may be configured with hardware, software, and/or firmware to allow its associated information handling system 105 to remotely boot from a computer-readable medium remote from information handling system 105 (e.g., a computer-readable medium coupled to network interface 135 via network 145).

Access controller 140 may be any system, device, apparatus or component of information handling system 105 configured to permit an administrator or other person to remotely monitor and/or remotely manage information handling system 105 (e.g., via an information handling system remotely connected to information handling system 105 via network 145) regardless of whether information handling system 105 is powered on and/or has an operating system installed thereon. In certain embodiments, access controller 140 may allow for out-of-band control of information handling system 105, such that communications to and from access controller 140 are communicated via a management channel physically isolated from the “in band” communication with network interface 135. Thus, for example, if a failure occurs in information handling system 105 that prevents an administrator from remotely accessing information handling system 105 via network interface 135 (e.g., operating system failure, power failure, etc.), the administrator may still be able to monitor and/or manage the information handling system 105 (e.g., to diagnose problems that may have caused failure) via access controller 140. In the same or alternative embodiments, access controller 140 may allow an administrator to remotely manage one or more parameters associated with operation of information handling system 105 (e.g., power usage, processor allocation, memory allocation, security privileges, etc.). In certain embodiments, access controller 140 may include or may be a Baseboard Management Controller (BMC), a Management Engine (ME), or an integral part of a Dell Remote Access Controller (DRAC), or an Integrated Dell Remote Access Controller (iDRAC), which are systems management hardware and software solutions operable to provide remote management capabilities.

The access controller 140 may include a processor communicatively coupled to a memory, storage media, and a network interface. The processor may also be electrically coupled to a power source dedicated to the access controller 140. The processor may include any system, device, or apparatus configured to interpret and/or execute program instructions and/or process data, and may include, without limitation a microprocessor, microcontroller, DSP, ASIC, or any other digital or analog circuitry configured to interpret and/or execute program instructions and/or process data. In some embodiments, the processor may interpret and/or execute program instructions and/or process data stored in the memory and/or another component of information handling system 105.

The memory of the access controller 140 may include any system, device, or apparatus configured to retain program instructions and/or data for a period of time (e.g., computer-readable media). By way of example without limitation, the memory may include RAM, EEPROM, a PCMCIA card, flash memory, magnetic storage, opto-magnetic storage, or any suitable selection and/or array of volatile or non-volatile memory that retains data after power to information handling system 105 is turned off or power to access controller 140 is removed. The network interface of the access controller 140 may include any suitable system, apparatus, or device operable to serve as an interface between the access controller 140 and the network 145. The network interface may enable access controller 140 to communicate over network 145 using any suitable transmission protocol and/or standard, including without limitation all transmission protocols and/or standards enumerated below with respect to the discussion of network 145.

The information handling system 105 may be operatively connected to one or more remote client information handling systems 150 over one or more networks 145. The network 145 may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet or any other appropriate architecture or system that facilitates the communication of signals, data and/or messages (generally referred to as data). The network 145 may transmit data using any storage and/or communication protocol, including without limitation, Fibre Channel, Frame Relay, Asynchronous Transfer Mode (ATM), Internet Protocol (IP), other packet-based protocol, small computer system interface (SCSI), Internet SCSI (iSCSI), Serial Attached SCSI (SAS) or any other transport that operates with the SCSI protocol, advanced technology attachment (ATA), serial ATA (SATA), advanced technology attachment packet interface (ATAPI), serial storage architecture (SSA), integrated drive electronics (IDE), and/or any combination thereof. The network 145 and its various components may be implemented using hardware, software, or any combination thereof.

The information handling system 105 and/or remote clients 150 may include one or more components that process and/or operate based on firmware embedded in or near the component. For example, such components may include hard disk drives (HDDs), CD-ROM drives, and DVD drives, and/or various other devices and the like that include controllers driven by firmware. Firmware may be the program code embedded in a storage device and maintained within or near the device. The firmware for a component most often comprises the operational code for the component. More generally, firmware may include program code operable to control a plurality of information handling system 105 operations. The memory system 115, BIOS memory 130, storage medium 120, and/or access controller 140 may, for example, store firmware such as Dell's Embedded System Management firmware, remote access controller (RAC) firmware, and PowerEdge Expandable RAID Controller (PERC) firmware, a basic input/output system (BIOS) program, and/or device drivers such as network interface card (NIC) drivers. A BIOS program may include software that facilitates interaction with and between the information handling system 105 devices such as a keyboard (not expressly shown), a mouse (not expressly shown), and/or one or more I/O devices. A device driver may include program code operable to facilitate interaction of a hardware device with other aspects of information handling system 105.

From time to time, it may be necessary and/or desirable to update or upgrade the firmware of a component at the remote client 150. For example, a firmware upgrade may be necessary to correct errors in, and/or improve the performance of, a component. The updates may be implemented in various ways depending on a given system software environment. The process of updating the firmware of a device is sometimes referred to as “flashing” the device, as the firmware update program will replace the software image stored in the flash memory with a second software image. The software updates may be contained in packages, such as self-contained file, for distribution and deployment. In certain embodiments, an update package may contain one or more of the following components, which may be needed by an application conforming to the Unified Extensible Firmware Interface (UEFI) specification, an industry specification that defines a software interface between an operating system and firmware.

An update package may contain an update package framework. This component may include files needed to run the update package while an operating system is running. An update package may contain one or more update package inventory/update modules. These components may include files needed to inventory and update a device. An update package may contain update package meta-data, which may be present in an XML file. This component may include files containing version information and release information such as iDrive release information. An update package may contain an update package image (i.e., payload). This component may be the information (image or payload data) which the update package is carrying for a target device. The image may be present under a “payload” folder inside the update package. The image may be in the form of one or more files with any number of sub-folders.

Updates may be installed with installers and/or other tools that work from within an operating system and may integrate update packages into a change management framework which may be used to manage an operating system. A software change management framework or system may comprise a collection of software programs to facilitate update installation, configuration and/or removal. To enable software change management systems to perform update and rollback functions for out-of-band change management, update packages may be supported with access controller 140. The update package may be a self-contained executable which can be run on an operating system to update BIOS, firmware or drivers on the system.

In certain embodiments, the processes may be automatic. In other embodiments, user intervention may be required. For example, a user may initiate an update package. The update package may perform an inventorying step for the device which it supports and then notify a user which version is installed on the information handling system and which version is present in the update package. A user can then continue with update execution to update the information handling system.

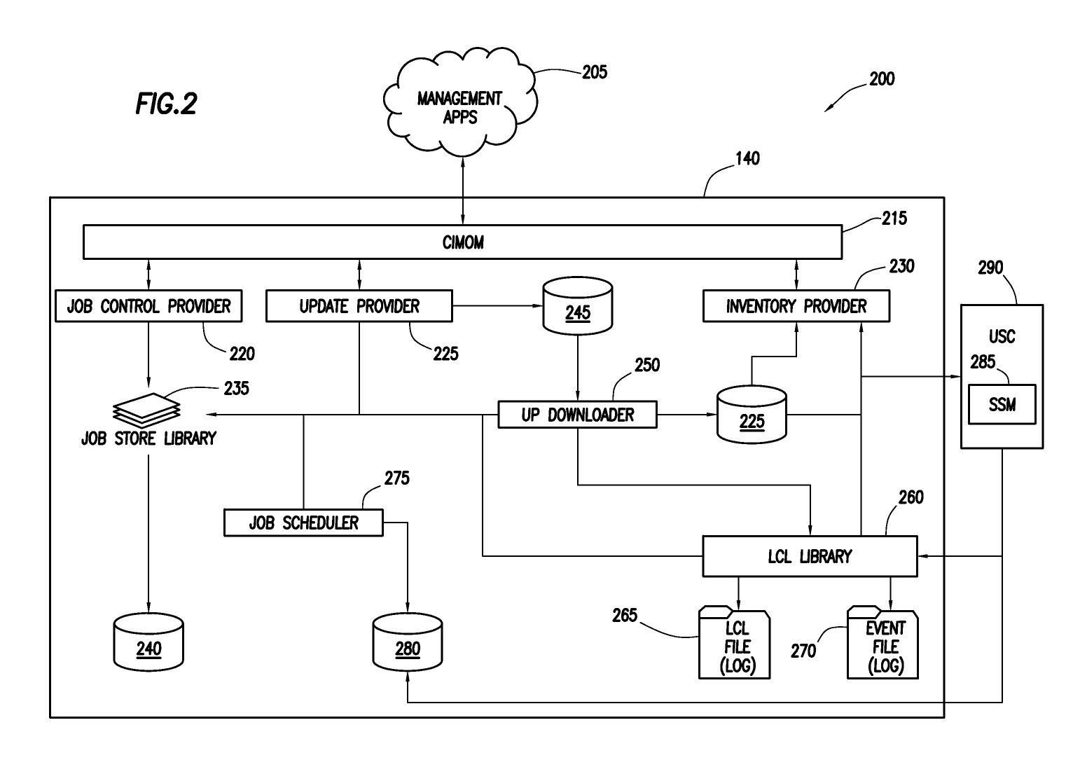

FIG. 2 illustrates a job control framework 200 in accordance with certain embodiments of the present disclosure. With the job control framework 200, a remote client may query for software inventory information and also may pass information for the performance of updates. An update command may be invoked to allow a remote client to download the payload and store the update information locally in a persistent storage. Each operation associated with an update may be assigned a Job ID (job instance identifier) that may be used later to set up the job or query status. The Job ID may then be scheduled to run immediately or at a later time. The information regarding when to run the job may be stored in a jobstore storage medium that may be persistent across multiple reboots. A persistent process may query the jobstore for jobs that meet the criteria to be staged. Once there are jobs to be applied, the scheduler may retrieve the scheduled job configuration and prepare data for the in-band processor to consume. The in-band process may reboot the system to UEFI to apply the update.

A client may utilize a management application 205 for interfacing with the information handling system 105. The management application 205 may be responsible for ensuring appropriate addressing for the target information handling system 105. In certain embodiments, the management application 205 may comprise a simple, standard interface such as WSMAN (WS-Management). As would be appreciated by one of ordinary skill in the art, WSMAN is a specification of a SOAP-based protocol for the management of servers, devices, applications and more. SOAP (Simple Object Access Protocol) is a protocol specification for exchanging structured information in computer networks.

The management application 205 may be implemented on the console side and may be configured to interface the access controller 140. As previously disclosed herein, certain embodiments of access controller 140 may include or may be a BMC, a ME, or an integral part of a DRAC or an iDRAC. The access controller 140 may include a Common Information Model Object Manager (CIMOM) 215, which may provide an interface between the management interface 205 and other components of the job control framework 200. The Common Information Model provides a common definition of management information for systems, networks, applications, and services, while allowing for vendor extensions of the same. CIM's common definitions enable vendors to exchange management information between systems throughout the network. The CIM schema provides the data model for each managed object of the system. Objects identify and describe the resources of the system.

The CIMOM 215 may provide an interface between a client and a job control provider module 220, an update provider module 225, and an inventory provider module 230. The providers may be configured to return software inventory from a life cycle log and firmware images available from an image repository, and to update BIOS/firmware. In certain embodiments, the image repository may be provided by way of a Managed System Service Repository (MASER). The job control provider 220 may be configured to interface with a jobstore library 235 and a jobstore database 240. The jobstore library 235 may be configured to create, update, and/or manage jobs in the jobstore database 240.

The update provider 225 may be configured to interface with a download queue 245 and an update package downloader 250. The update package downloader 250 may be a module configured to pick up tasks from the download queue 245, download an update package, extract it, and transfer it to an image repository 255. When the update provider 225 receives a request, it may query the jobstore library 235 for a Job ID and then transfer it to the user. The update provider 225 may also write the Job ID and any input parameters passed by the user to the update provider 225 to the download queue 245. For example, the update provider 225 may write the information to an XML file in the download queue 245. The downloader 250 may read from the download queue 245 and download the update package. If multiple update requests are received, then the downloads may be queued. In certain embodiments, the download queue 245 may reside in SPI (serial peripheral interface) flash memory and may consume minimal memory space. The inventory provider 230 may be configured to interface with the image repository 255. The downloader 250 may interface with a Life Cycle Log(LCL) Library 260 that may be used to read/write data from/to a LCL file 265 and an event file 270. Update actions may be recorded and stored in one or more of the jobstore library 235, jobstore database 240, LCL 260, LCL file 265, and event file 270.

A job scheduler 275 may be a daemon which schedules jobs by creating a list of tasks to be executed in a task file 280, which may be a text file in any suitable format, including SSIB (system services information block). The job scheduler 275 may also set a flag so that the system will enter a unified server configurator (USC) mode upon next reboot. For example, a flag may be set in a system service manager (SSM) 285, which may be an application that runs in the UEFI environment and is responsible for launching the tasks indicated in the task file 280. The SSM 285 may interface with the USC module 290. The USC may provide a single place to perform firmware and other updates, hardware and RAID configuration, native deployment of operating systems, and system diagnostics—one that functions independently of both media and platform OS. Thus, the USC 290 may be available even when the OS is not.

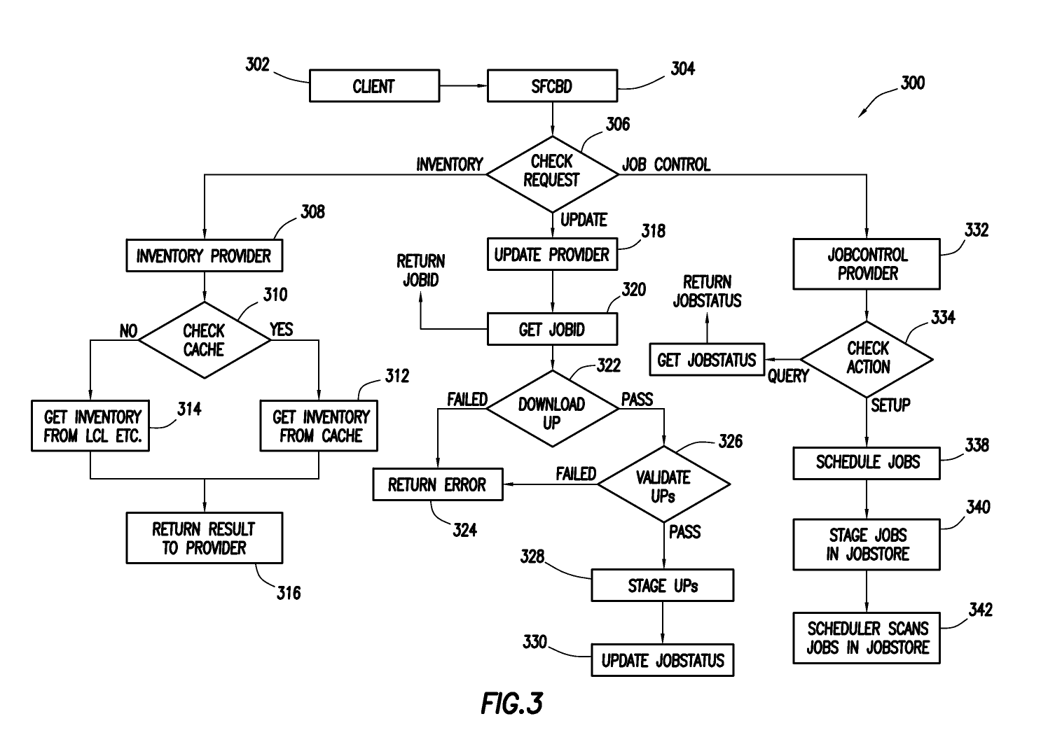

FIG. 3 shows a control flow diagram 300 in accordance with certain embodiments of the present disclosure. According to one embodiment, the control flow diagram 300 may begin at step 302. Teachings of the present disclosure may be implemented in a variety of configurations of the example distributed computing environment 100. As such, the order of the steps comprising the control flow diagram 300 may depend on the implementation chosen.

At step 302, an application may send one or more commands or requests. In certain embodiments, a control application of a remote client may send WSMAN commands to remote enablement application in an access controller. A command or request may be received by the access controller at step 304. In a specific non-limiting example, the command or request may be received by CIMOM 205. At step 306, it may be determined whether the command or request should be handled by inventory, update, or job control provider modules. A small footprint CIM broker daemon (SFCBD), for example, may make that determination.

In the case of an inventory request, an inventory provider may handle the request at step 308. At step 310, the inventory provider may determine whether the relevant software data should be provided from cache. Based on that determination, the inventory may be retrieved from the cache at step 312 and, if a cache file exists, the process may proceed to step 316. At step 316, the inventory provider may compare the cache file contents to LCL to determine whether the cache file contents are current. If the cache file contents are current, the result may be returned to the client via the SFCBD. If not, the process may continue at step 314.

At step 314, the inventory may be retrieved via the LCL library if a cache file does not exist or is not current. The software inventory feature may return the current inventory of the installed devices on the system as reported by the LCL and the inventory of available BIOS/firmware on a firmware images partition of the image repository. In certain embodiments, the image repository may be provided by way of a MASER. The inventory of both the “current” version of BIOS/firmware on the image repository and the “previous” version (i.e., N and N−1 versions) may be returned to the inventory provider at step 316. From the inventory provider, the inventory may be returned to the client via the SFCBD.

In the case of an update request, an update provider may handle the request at step 318. At step 320, an update Job ID may be created and/or retrieved from the jobstore library and returned to the console. At step 322, an update package may be downloaded from a network location to a partition of an image repository. If the download failed, an error may be returned at step 324. With a successful download, the update package is validated at step 326. Failed validation may result in an error return at step 326. Some updates may be performed directly, without staging. These updates may be applied after downloading, using job scheduling. Other updates may be staged updates that use job scheduling. These update packages may be staged at step 328 using the task list file, for example. A downloaded update package may be extracted and transferred to an image repository. The actual update may be performed by the USC. After a successful download and extraction, the job status in the jobstore library and/or database may be updated at step 330. After the status update, the client may schedule an update for the job with a job control request.

In the case of a job control request, a job control provider may handle the request at step 332. For example, once an update Job ID is returned to the console and the content is downloaded, a console may send a request to a job control provider to query update job status and schedule running the job. The request may indicate a start time and/or other timing information, such as a triggering event. At step 334, it may determined whether to query job state or continue with setup. At step 336, the job status may be retrieved and returned. At step 338, the job may be scheduled.

The job control provider may support multiple jobs grouped together as a job array. In certain embodiments, the job scheduling may be performed by a stand-alone application. Once a set of jobs are scheduled, they may be saved to the jobstore library and/or database at step 340. At step 342, a job scheduler may scan the jobstore library and/or database periodically (e.g., at 30-second intervals) to check if there are jobs that meet the criteria for execution. The jobs that meet the criteria may be staged into the task list file and a reboot of the system to USC may trigger the actual update. After performing the update, the USC may pass the result to the LCL and the job status may be updated.

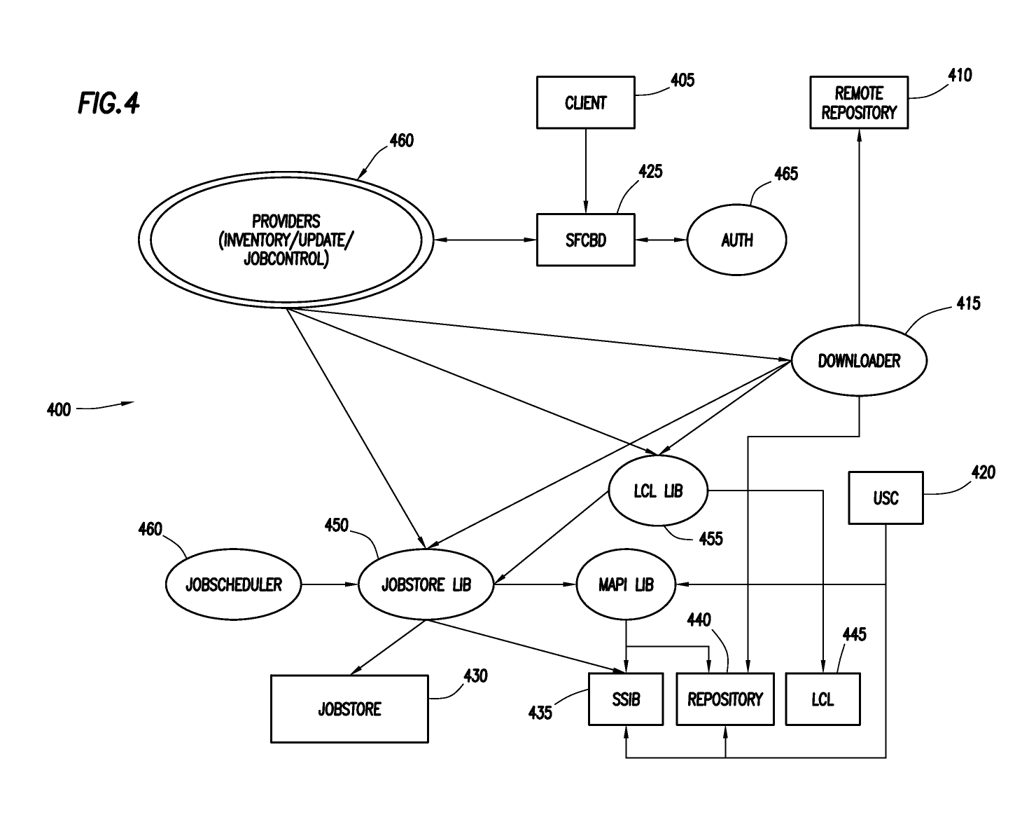

FIG. 4 shows an architectural data flow diagram 400 in accordance with certain embodiments of the present disclosure. The majority of the data flow may be inside access controller space. A client 405 may be remote to the access controller and may be allowed to query the inventory of the access controller. Where the client 405 is an administrator, the client 405 may be allowed to perform remote update, job control, and job scheduling. Where the client 405 is not an administrator but an operator, for example, remote server execution enablement may be required for the client 405 to perform remote update, job control, and job scheduling.

In certain embodiments, a remote repository 410 may be remote to the access controller and configured to interface with a downloader module 415 via a network. The remote repository 410 may host contents to be used to update system firmware and BIOS. Address information of the remote repository 410 may be provided by the client 405. In the alternative or in addition to the remote repository 410, certain embodiments may employ a local repository 440. In certain embodiments, one or more of repository may be provided by way of a MASER.

A USC 420 may be external and configured to interface with the SFCBD 425 of the access controller. The SFCBD 425 may handle all requests/commands from the client 405. The SFCBD 425 may serve as a gateway to, and a control daemon for, all providers 460. The security managed by an access controller authentication mechanism 465. The jobstore storage medium 430, the task file 435, an image repository 440, and LCL 445 may be persistent data stores for the architectural data flow diagram 400. The jobstore library 450 may control the jobstore 430. The job scheduler 460 may scan the jobstore library 450 and/or database 430 periodically for jobs ready for execution. The LCL library 455 may control the LCL 445. The jobstore library 450 and the USC 420 may access the task file 435. The image repository 440 may be controlled by downloader 415 and accessed by USC 420. The data stores may be managed by sessions and file locking flags to prevent concurrent write to the partitions and files.

Accordingly, the present disclosure provides systems and methods for host-level distributed scheduling in a distributed computing environment. Certain embodiments provide a technology for distributed remote scheduling with adjustable network dependency and no dependency on the state of the host system. Certain embodiments provide a key embedded systems management capability that allows systems administrators to use a simple standard interface to manage servers with remote rescheduling, update, and deployment capabilities. Certain embodiments provide a distributed scheduling infrastructure that allows payload and configurations to be pushed onto target systems prior to time of operation. These and other technical advantages will be apparent to those of ordinary skill in the art in view of this disclosure.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. Also, the terms in the claims have their plain, ordinary meaning unless otherwise explicitly and clearly defined by the patentee. The indefinite articles “a” or “an,” as used in the claims, are each defined herein to mean one or more than one of the element that it introduces.

What is claimed is:

1. A system for host-level distributed scheduling of a software installation in a distributed computer environment, comprising:
an information handling system comprising an out-of-band processor that is operable to communicatively connect to a second information handling system via a network, wherein the information handling system is configured to:
retrieve an identifier indicative of a software installation consequent to a software installation request being invoked;
download a software installation package via the network, wherein the software installation package comprises a payload;
store the payload in an image repository;
schedule the software installation to occur based, at least in part, on the identifier and a timing parameter;
store software installation information in a nonvolatile memory medium; and
perform the software installation according to the scheduling, wherein the scheduling and the performing of the software installation is without dependency on the information handling system being communicatively connected to the network;
wherein one or more of the retrieving, downloading, storing the payload, scheduling, and storing software installation information is performed, at least in part, with the out-of-band processor.

2. The system for host-level distributed scheduling of a software installation in a distributed computer environment according to claim 1, wherein scheduling information based on the scheduling is persistently stored so as to persist across multiple reboots of the information handling system.

3. The system for host-level distributed scheduling of a software installation in a distributed computer environment according to claim 2, wherein the information handling system is further configured to:
consequent to an inventory request, retrieve a current inventory of installed devices on the information handling system and available software installation images stored in the information handling system.

4. The system for host-level distributed scheduling of a software installation in a distributed computer environment according to claim 3, wherein the performing of the software installation does not occur until after a subsequent boot of the information handling system.

5. The system for host-level distributed scheduling of a software installation in a distributed computer environment according to claim 4, wherein the information handling system comprises a universal server configurator that is configured to perform the software installation without dependence on an operating system.

6. The system for host-level distributed scheduling of a software installation in a distributed computer environment according to claim 4, wherein the information handling system further comprises a job scheduler configured to scan for software installations that ready for scheduling.

7. The system for host-level distributed scheduling of a software installation in a distributed computer environment according to claim 5, wherein the scheduling is performed, at least in part, by updating a task file and setting a flag indicating that the universal server configurator is to perform the software installation with the subsequent boot of the information handling system.

8. A method for host-level distributed scheduling of a software installation in a distributed computer environment, the method comprising:
providing an information handling system that is operable to communicatively connect to a second information handling system via a network, wherein the information handling system is configured to:
retrieve an identifier indicative of a software installation consequent to a software installation request being invoked;
download a software installation package via the network, wherein the software installation package comprises a payload;
locally store the payload in an image repository;
schedule the software installation to occur based, at least in part, on the identifier and a timing parameter;
store software installation information in a nonvolatile memory medium; and
perform the software installation according to the scheduling, wherein the scheduling and the performing of the software installation is without dependency on the information handling system being communicatively connected to the network.

9. The method for host-level distributed scheduling of a software installation in a distributed computer environment according to claim 8, wherein scheduling information based on the scheduling is persistently stored so as to persist across multiple reboots of the information handling system.

10. The method for host-level distributed scheduling of a software installation in a distributed computer environment according to claim 9, wherein the information handling system is further configured to:
consequent to an inventory request, retrieve a current inventory of installed devices on the information handling system and available software installation images stored in the information handling system.

11. The method for host-level distributed scheduling of a software installation in a distributed computer environment according to claim 10, wherein the performing of the software installation does not occur until after a subsequent boot of the information handling system.

12. The method for host-level distributed scheduling of a software installation in a distributed computer environment according to claim 11, wherein the information handling system comprises a universal server configurator that is configured to perform the software installation without dependence on an operating system.

13. The method for host-level distributed scheduling of a software installation in a distributed computer environment according to claim 11, wherein the information handling system further comprises a job scheduler configured to scan for software installations that ready for scheduling.

14. The method for host-level distributed scheduling of a software installation in a distributed computer environment according to claim 12, wherein the scheduling is performed, at least in part, by updating a task file and setting a flag indicating that the universal server configurator is to perform the software installation with the subsequent boot of the information handling system.

15. A computer-readable storage medium comprising executable instructions that, when executed by a processor of an information handling system that is operable to communicatively connect to a second information handling system via a network, cause the processor to:
retrieve an identifier indicative of a software installation consequent to a software installation request being invoked;
download a software installation package via the network, wherein the software installation package comprises a payload;
locally store the payload in an image repository;
schedule the software installation to occur based, at least in part, on the identifier and a timing parameter;
store software installation information in a nonvolatile memory medium; and
perform the software installation according to the scheduling, wherein the scheduling and the performing of the software installation is without dependency on the information handling system being communicatively connected to the network.

16. The computer-readable storage medium according to claim 15, wherein scheduling information based on the scheduling is persistently stored so as to persist across multiple reboots of the information handling system.

17. The computer-readable storage medium according to claim 16, wherein the executable instructions further cause the processor to:
consequent to an inventory request, retrieve a current inventory of installed devices on the information handling system and available software installation images stored in the information handling system.

18. The computer-readable storage medium according to claim 17, wherein the performing of the software installation does not occur until after a subsequent boot of the information handling system.

19. The computer-readable storage medium according to claim 18, wherein the information handling system comprises a universal server configurator that is configured to perform the software installation without dependence on an operating system.

20. The computer-readable storage medium according to claim 18, wherein the scheduling is performed, at least in part, by updating a task file and setting a flag indicating that the universal server configurator is to perform the software installation with the subsequent boot of the information handling system.
